(19) United States
(12) Patent Application Publication
(10) Pub. No.: US 2026/0119877 A1
(43) Pub. Date: Apr. 30, 2026

(54) SYSTEMS AND METHODS FOR AUTOMATED HIDDEN NEURON OPTIMIZATION

(71) Applicant: UNIVERSITY OF SOUTH FLORIDA, Tampa, FL (US)

(72) Inventors: Srinivas KATKOORI, Tampa, FL (US); Susmitha BOYIDAPU, Tampa, FL (US); Lakshmikavya KALYANAM, Tampa, FL (US)

(21) Appl. No.: 19/373,567

(22) Filed: Oct. 29, 2025

Related U.S. Application Data
(60) Provisional application No. 63/713,382, filed on Oct. 29, 2024.

(51) Int. Cl. G06N 3/082

(52) U.S. Cl. CPC G06N 3/082

(57) ABSTRACT

Systems and methods for automated hidden neuron optimization are provided. A method includes: pre-processing a dataset, performing a hybrid feature selection process on the pre-processed dataset, including: selecting features based on a Mutual Information selection technique including: determining and ranking mutual information values, determining a cumulative sum of the ranked values, and retaining available features accounting for a threshold percentage of the cumulative sum, and selecting retained available features based on a Random Forest selection technique, generating a multilayer perceptron (MLP) model including: a hidden layer including one or more hidden neurons, and dynamically selecting a model architecture of a plurality of versions of the MLP model by: iteratively operating versions of the MLP model including: training each of the plurality of versions of the MLP model on the dataset, performing multiple-fold cross-validation on each version, recording performance metrics for each fold, and averaging the performance metrics across all folds.

### CROSS-REFERENCE TO RELATED APPLICATION(S)

This application claims the benefit of and priority to U.S. Provisional Patent Application No. 63/713,382, filed on Oct. 29, 2024, which is hereby incorporated by reference in its entirety for all purposes.

### TECHNICAL FIELD

This disclosure generally relates to systems and methods for automated hidden neuron optimization.

### BACKGROUND

Balancing the architecture of neural networks is crucial for achieving optimal classification performance. Striking the right equilibrium between accuracy and computational efficiency is particularly important when designing multilayer perceptron (MLP) models. The number of neurons in the hidden layers significantly impacts the model's ability to generalize and its computational requirements. Too few neurons may cause underfitting, limiting the model's capacity to learn from diverse datasets, while too many neurons can lead to increased processing time and energy consumption. Identifying the ideal neuron count helps achieve both high performance and efficiency. Automating the process of determining the optimal configuration ensures that models can adapt to varying data complexities without unnecessary computational overhead. This careful balance is vital for developing scalable and reliable classification systems.

Several strategies have been proposed to optimize neural network architectures, including grid search, random search, and advanced methods like Neural Architecture Search (NAS) and evolutionary algorithms. In addition, feature selection techniques have been employed to reduce data complexity and improve model performance, which is critical for ensuring efficient processing in environments with limited computational resources. While these methods are effective, they often demand considerable computational power or lack flexibility when dealing with diverse and evolving datasets. Moreover, there is limited research on combining feature selection with neuron optimization in a unified, automated framework. This emphasizes the need for a systematic approach that enhances model accuracy while ensuring scalability, efficiency, and quick decision-making across various applications.

Accordingly, there is a need for systems and methods for automated hidden neuron optimization.

### SUMMARY

This disclosure pertains to systems and methods for automated hidden neuron optimization.

A first aspect of this disclosure pertains to a method, including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an F1 score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.

A second aspect of this disclosure pertains to the method of the first aspect, wherein the pre-processing includes data cleaning including: correcting one or more of inconsistencies or errors, and addressing missing information using one or more of imputation or deletion processes.

A third aspect of this disclosure pertains to the method of the first aspect, wherein the Random Forest classifier model includes at least 100 decision trees.

A fourth aspect of this disclosure pertains to the method of the first aspect, wherein: a number of the plurality of epochs is ≥1000 epochs, and the training utilizes an Adam optimizer with cross-entropy loss for multi-class problems or binary cross-entropy loss for binary classifications.

A fifth aspect of this disclosure pertains to the method of the first aspect, wherein the performance metrics further include precision and recall.

A sixth aspect of this disclosure pertains to the method of the first aspect, wherein the performance threshold percentage for the stopping mechanism is at least 0.5% over five consecutive epochs.

A seventh aspect of this disclosure pertains to the method of the first aspect, wherein the defined margin is 2%.

An eighth aspect of this disclosure pertains to the method of the first aspect, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.

A ninth aspect of this disclosure pertains to one or more non-transitory computer-readable media storing instructions that, when executed by at least one processor of a computing system, cause the computing system to perform operations, the operations including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an F1 score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.

A tenth aspect of this disclosure pertains to the one or more non-transitory computer-readable media of the ninth aspect, wherein the pre-processing includes data cleaning including: correcting one or more of inconsistencies or errors, and addressing missing information using one or more of imputation or deletion processes.

An eleventh aspect of this disclosure pertains to the one or more non-transitory computer-readable media of the ninth aspect, wherein the Random Forest classifier model includes at least 100 decision trees.

A twelfth aspect of this disclosure pertains to the one or more non-transitory computer-readable media of the ninth aspect, wherein: a number of the plurality of epochs is ≥1000 epochs, and the training utilizes an Adam optimizer with cross-entropy loss for multi-class problems or binary cross-entropy loss for binary classifications.

A thirteenth aspect of this disclosure pertains to the one or more non-transitory computer-readable media of the ninth aspect, wherein the performance metrics further include precision and recall.

A fourteenth aspect of this disclosure pertains to the one or more non-transitory computer-readable media of the ninth aspect, wherein the performance threshold percentage for the stopping mechanism is at least 0.5% over five consecutive epochs.

A fifteenth aspect of this disclosure pertains to the one or more non-transitory computer-readable media of the ninth aspect, wherein the defined margin is 2%.

A sixteenth aspect of this disclosure pertains to the one or more non-transitory computer-readable media of the ninth aspect, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.

A seventeenth aspect of this disclosure pertains to a system, including: one or more processors, and at least one memory including at least one non-transitory computer-readable medium storing instructions that, when executed by at least one of the one or more processors, cause the system to perform operations, the operations including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an Fa score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.

An eighteenth aspect of this disclosure pertains to the system of the seventeenth aspect, wherein the pre-processing includes data cleaning including: correcting one or more of inconsistencies or errors, and addressing missing information using one or more of imputation or deletion processes.

A nineteenth aspect of this disclosure pertains to the system of the seventeenth aspect, wherein the performance threshold percentage for the stopping mechanism is at least 0.5% over five consecutive epochs.

A twentieth aspect of this disclosure pertains to the system of the seventeenth aspect, wherein the defined margin is 2%.

A twenty-first aspect of this disclosure pertains to the system of the seventeenth aspect, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIG. 1 is a schematic view of an example multilayer perceptron (MLP) network.

FIG. 2 is a flowchart for a workflow according to an example embodiment of the present disclosure.

FIGS. 3 and 4 are graphs of experimental results using a Fetal Health dataset.

FIGS. 5A-5I are flowcharts for an example method.

FIG. 6 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, specific embodiments are shown in the drawings and will be described in detail herein with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

Determining the optimal number of hidden neurons in a multilayer perceptron (MLP) network remains a significant challenge in machine learning, with no universally optimal method identified to date. While various approaches such as analytical, pruning, constructive, and evolutionary methods have been proposed, they often fall short of providing an ideal solution. Example embodiments of the present disclosure provide a novel approach to address this challenge, combining pre-processing, feature selection, and strategic MLP architecture construction. Example embodiments may begin with a comprehensive data pre-processing stage, followed by a hybrid feature selection method to identify the most relevant input variables. Utilizing these selected features, example embodiments may construct an MLP architecture and implement k-fold cross-validation for robust training to find the optimal number of hidden neurons. To prevent overfitting and unnecessary computational expense, example embodiments may incorporate an early stopping mechanism. The key innovation of the disclosed approach lies in its ability to dynamically determine the optimal number of hidden neurons while simultaneously maximizing model performance. By iteratively adjusting the hidden layer configuration and evaluating performance metrics, example embodiments may identify the most effective network structure for the given classification task. The inventors conducted experiments to compare the experimental results of seven classification datasets from the University of California, Irvine (UCI) machine learning library and KAGGLE® to evaluate our method. In the experiments, the breast cancer dataset achieved 95.07% accuracy with two hidden neurons. The inventors found that the optimal network configuration that has fewer hidden neurons and still has good model performance.

Example embodiments may integrate both feature selection and neuron optimization into a unified framework. Feature selection plays a critical role in reducing the dimensionality of the input data, which directly influences the number of neurons required in hidden layers of the MLP model. By selecting only the most relevant features, example embodiments can minimize the computational burden, allowing the network to focus on key data points without wasting resources on irrelevant information.

Example embodiments may provide a systematic approach to determine the optimal number of neurons in the hidden layers of a MLP model for classification tasks. The inventors experimented with various neuron configurations on multiple classification datasets, and evaluated the model performance based on accuracy and F1 score. To find the optimal network size, the inventors performed pre-processing, a feature selection process, and then finally, the MLP model was used on datasets. The inventors implemented different feature selection methods and compared them using the final MLP framework. In example embodiments, the optimal number of neurons in the hidden layer is automatically calculated within the MLP framework, resulting in improved performance and the best possible accuracy for the given dataset.

Example embodiments may identify the optimal number of neurons in an MLP model, utilizing an approach that integrates feature selection methods and advanced optimization techniques. Example embodiments may employ a hybrid methodology of selecting features, e.g., by utilizing Mutual Selection and Random Forest techniques for feature selection. By reducing the dimensionality of the input data, the example model is able to focus on the most relevant features, thereby enhancing performance and computational efficiency. In addition to feature selection, example embodiments may provide an innovative use of cross-validation within the MLP model. For example, example embodiments may ensure that the same initial weights and biases are assigned across all folds during the cross-validation process, which may minimize variability and provide more reliable and consistent performance metrics. Furthermore, including early stopping may help prevent overfitting, ensuring that the model generalizes well to unseen data. The combination of these disclosed techniques may lead to a more efficient and compact neural network model, requiring fewer neurons while maintaining or even improving accuracy compared to previous approaches. Example embodiments may directly address a key challenge in neural network design: optimizing network complexity without sacrificing performance.

### Multilayer Perceptron (MLP) Architecture

Multilayer perceptrons (MLPs) are a fundamental class of artificial neural networks (ANNs) that have become a cornerstone in various machine learning applications. These versatile networks include interconnected neurons organized into layers: an input layer, one or more hidden layers, and an output layer. The architecture of MLPs allows them to learn complex, non-linear relationships in data, making them powerful tools for a wide range of tasks. MLPs excel in several key areas, including classification, regression, pattern recognition, function approximation, and feature learning. In classification tasks, MLPs can effectively categorize input data into predefined classes, making them valuable in applications such as image recognition, spam detection, and medical diagnosis. For regression problems, these networks can model continuous outcomes, proving useful in predicting stock prices, estimating housing values, or forecasting energy consumption. Their ability to identify complex patterns in data makes them crucial in fields like speech recognition, handwriting analysis, and anomaly detection.

MLPs are highly adaptable, learning from examples through backpropagation and adjusting their weights to minimize errors. When properly trained, they demonstrate strong generalization capabilities, making accurate predictions on unseen data. Additionally, MLPs can handle high-dimensional input data, making them suitable for complex, real-world problems. One of the critical aspects of MLP design is determining the optimal number of neurons in the hidden layers. This choice significantly affects the model's overall performance, as it governs the network's capacity to learn complex patterns and generalize effectively to new, unseen data. Despite the significance of this issue, there is no universal formula or method for determining the optimal number of neurons in a hidden layer. The process of identifying the optimal configuration typically relies on experimentation, as it can be influenced by many factors such as the number of features, the size of the dataset, the complexity of the task, and the overall architecture of the model. This flexibility, while challenging, allows MLPs to be tailored to specific problem domains, balancing between the model's capacity to learn complex patterns and its ability to generalize effectively.

### Role of Hidden Layers in MLPs

The hidden layers in MLPs extract and combine features from the input data, enabling the model to learn complex nonlinear relationships. The number of neurons in these layers directly impacts the model's ability to capture patterns and generalize to unseen data. Insufficient neurons can lead to underfitting, in which the model is unable to learn the underlying complexities of the data. Conversely, an excessive number of neurons can result in overfitting, in which the model memorizes the training data, but fails to perform well on new, unseen examples. Finding the optimal number of neurons in the hidden layers is important for balancing model accuracy, complexity, and resource efficiency.

Example embodiments may apply the following general rules for determining the number of neurons in hidden layers:
The number of neurons in the hidden layer may be approximately two-thirds (or between 70% and 90%) of the size of the input layer. If this number is insufficient, additional neurons can be added later based on the output layer's size.
The number of neurons in the hidden layer may be less than twice the number of neurons in the input layer.
The size (or number) of the hidden layer neurons may fall between the sizes (or numbers) of the input layer and the output layer.

These rules provide a useful framework for establishing an effective architecture for neural networks.

### Data Pre-Processing

Data pre-processing is an important (and sometimes overlooked) step in the machine learning process that establishes the foundation for creating reliable and accurate models. This complex process entails converting unprocessed data into a format that is clear, uniform yet suitable for modeling and analysis. One of the most important parts of data pre-processing is data cleaning, in which inconsistencies or errors are corrected and addresses missing information using methods like imputation or deletion. Data transformation is an important process that includes duties like encoding categorical variables to make them acceptable for mathematical operations and standardizing or normalizing characteristics to bring them to a common scale. Another important step is feature selection, which involves selecting the most pertinent characteristics to enhance model performance and minimize overfitting. Through this procedure, which may greatly improve model efficiency and interpretability, the most useful features are identified and retained, while redundant or unnecessary ones are discarded. Feature engineering is generating new, significant features from the existing data to improve the predictive capacity of the model.

Pre-processing also frequently addresses issues such as managing unbalanced datasets, identifying and managing outliers, and minimizing dimensionality to efficiently manage high-dimensional data. Specialized processing methods capture the unique characteristics of certain data types, such as text or time series. Data preparation is very important, as it has a direct effect on the quality of insights obtained from the data and the effectiveness of machine learning models. Implementing pre-processing steps ensures that data is relevant, clean, and structured correctly, and provides the path for more precise predictions, less computing complexity, and enhanced model generalization, all of which contribute to more reliable and valuable outcomes in data-driven decision-making processes.

### Feature Selection

Feature selection is an important process in machine learning that involves identifying and selecting the most relevant features from a dataset to build effective predictive models. This process is important for improving model performance, reducing overfitting, reducing storage requirements, enhancing model interpretability, and decreasing computational complexity. By eliminating irrelevant or redundant features, feature selection helps in focusing on the most informative aspects of the data, thereby leading to more accurate and efficient models. Feature selection methods may be categorized into the following four categories:
1. Filter methods use specified threshold values to assess features according to their statistical traits concerning the target variable. These techniques can be applied to high-dimensional datasets since they are computationally efficient. They perform apart from the learning process, evaluating features using chi-squared tests, mutual information, and correlation coefficients, among other statistical metrics. They are ranked with criteria and high-ranked features are selected. Filter approaches are quick and easy to use, but because they disregard the requirements of the learning algorithm or feature interactions into consideration, they may fail to deliver the best feature subsets.
2. Wrapper methods evaluate feature subsets through the performance evaluation of the model during the training phase. In these methods, a classifier is trained on numerous feature subsets, and its performance is validated through techniques such as cross-validation. This method is customized for the particular learning algorithm and permits the consideration of feature interactions. These methods need more model training and validation phases, which makes them computationally challenging. Large datasets or complicated models may be more sensitive to this increased processing expense.
3. Embedded methods allow for the simultaneous optimization of model parameters and feature identification by incorporating the selection process directly into the model training phase. These approaches consider feature interactions, which makes them more efficient than filter approaches and more computationally efficient than wrapper methods. Popular methods include decision tree-based significance measurements from algorithms like Random Forests and Gradient Boosting, and regularization techniques like Lasso and Ridge regression, which penalize less significant features. These methods minimize the likelihood of overfitting and provide subsets of features that are optimized for the learning algorithm by determining the importance of each feature during the training process.
4. Hybrid methods utilize a combination of the above techniques, such as Filter and Wrapper Methods combined or Filter and Embedded methods together.

Choosing between filter, wrapper, embedded, and hybrid approaches depends upon the requirements of the task, the dataset size, the computational resources, and its need for model interpretability. Each approach has advantages and is appropriate for certain situations in the machine learning pipeline.

Recent research has focused on developing efficient methods to determine the optimal number of hidden nodes in neural networks, particularly for single hidden layer feedforward networks (SLFNs). These approaches aim to improve network performance while reducing the computational cost associated with traditional trial-and-error methods. One study introduced a singular value decomposition method for estimating the optimal number of hidden neurons in SLFNs. Their approach involved normalizing the training dataset and applying singular value decomposition to obtain eigenvalues. The number of hidden nodes was then determined based on these eigenvalues. For the Modified National Institute of Standards and Technology (MNIST) dataset, they found that 282 to 293 hidden nodes were optimal, while the Air Pressure System (APS) dataset required 97 to 100 hidden nodes for best performance. The effectiveness of this method mainly relied on the normalization of training data. However, the specific normalization techniques used in that study might not be suitable for all types of data or problems. Improper normalization can affect the performance by estimating the inaccurate number of hidden neurons. Another study developed a system that predicts the optimal number of hidden nodes from a small number of sample topologies. That system operated in phases, including data splitting, sampling representative topologies, fitting an error curve, and predicting the optimal number of hidden nodes. Using the MATLAB® Engine Data Set, they demonstrated that networks built with their system could achieve generalization errors as low as 0.4% greater than exhaustive search methods while being 20 times faster. Generally, the optimal number of hidden nodes depends upon various domain-specific factors. However, the extent to which that system can adapt to or account for these factors in its predictions is not fully explored.

Another study proposed a method using polynomial regression to predict the optimal number of neurons in feed-forward neural networks for breast cancer diagnosis. Their approach involved applying polynomial regression to the training dataset to capture performance and accuracy, then calculating upper and lower bounds for the number of hidden nodes. For the Digital Database for Screening Mammography (DDSM) dataset, they determined a vertex of 49 neurons with bounds of 34 to 64, while the UCI dataset showed a vertex of 48 neurons with bounds of 33 to 63. The highest-performing classifier had 41 neurons and achieved 89.17% accuracy. That approach necessitated conducting a series of baseline experiments to determine the search bounds for the optimal number of neurons, which could be seen as a limitation because it requires computational resources upfront and may not be entirely feasible for extremely large datasets.

Yet another study introduced a two-phase method for determining the optimal number of neurons in the hidden layer of a three-layer neural network. The first phase used backpropagation to identify candidate numbers of neurons, while the second phase tested the network's generalization capacity to select the optimal number. Using data from an exclusive-or (XOR) circuit experiment, they found that 25 neurons in the hidden layer achieved the highest correctness rate in prediction accuracy.

Another study explored optimizing neural network hyperparameters within the Generative Adversarial Networks (GANs) architecture for intrusion detection systems. Their method involved incrementally increasing the number of hidden layers and neurons in both the generator and discriminator components of GANs. Using the Knowledge Discovery and Data Mining 1999 (KDD99) dataset, they determined that an optimal configuration included 10 hidden layers and 1024 neurons in the generator, and 2 hidden layers and 64 neurons in the discriminator, achieving an accuracy of 0.9991.

The diverse approaches used in the various studies demonstrate the ongoing efforts to develop more efficient and accurate methods for determining the optimal number of hidden nodes in neural networks. While each method has its strengths, they also come with limitations, such as dataset specificity, computational requirements, and assumptions about data relationships. These existing methods have primarily focused on single hidden layer feedforward networks or specific applications, such as breast cancer diagnosis and intrusion detection systems. However, there remains a need for a more comprehensive and adaptable approach that can be applied across various classification tasks and datasets. Furthermore, most of the existing methods do not incorporate feature selection techniques or consider the impact of different pre-processing steps on the optimal network architecture. This gap in the current research presents an opportunity for developing a more robust and versatile method for determining the optimal number of neurons in hidden layers.

Example embodiments of the present disclosure address these limitations by introducing a systematic approach that combines pre-processing, feature selection, and automatic neuron optimization within an MLP framework. By experimenting with various neuron configurations on multiple classification datasets from the UCI machine learning repository, the inventors developed a more universally applicable technique that can adapt to different classification tasks while maintaining high performance in terms of accuracy and F1 score. This approach not only builds upon the strengths of existing methods, but also introduces novel elements, such as the integration of feature selection and automatic neuron calculation within the MLP framework. By doing so, example embodiments may provide a more comprehensive solution for optimizing neural network architectures across diverse classification problems. The disclosed technique not only builds upon the strengths of existing methods but also introduces novel elements such as the integration of feature selection and automatic neuron calculation within the MLP framework. By doing so, example embodiments may provide a more comprehensive solution for optimizing neural network architectures across diverse classification problems by integrating the two methods into a hybrid approach.

### Optimization

Example embodiments may provide a systematic approach to determine the optimal number of neurons in the hidden layers of an MLP model for classification tasks. In developing the disclosed technique, the inventors experimented with various neuron configurations on multiple classification datasets from the UCI machine learning repository, evaluating the model performance based on accuracy and F1 score. To find the optimal network, example embodiments may pre-process the datasets, and then find the optimal network configuration of the MLP model to evaluate on datasets. Example embodiments may implement different feature selection methods, such as Mutual Information and Random Forest techniques to select input features. In example embodiments, the optimal number of neurons in the hidden layer may be automatically calculated, resulting in improved performance and the best possible accuracy for the given dataset.

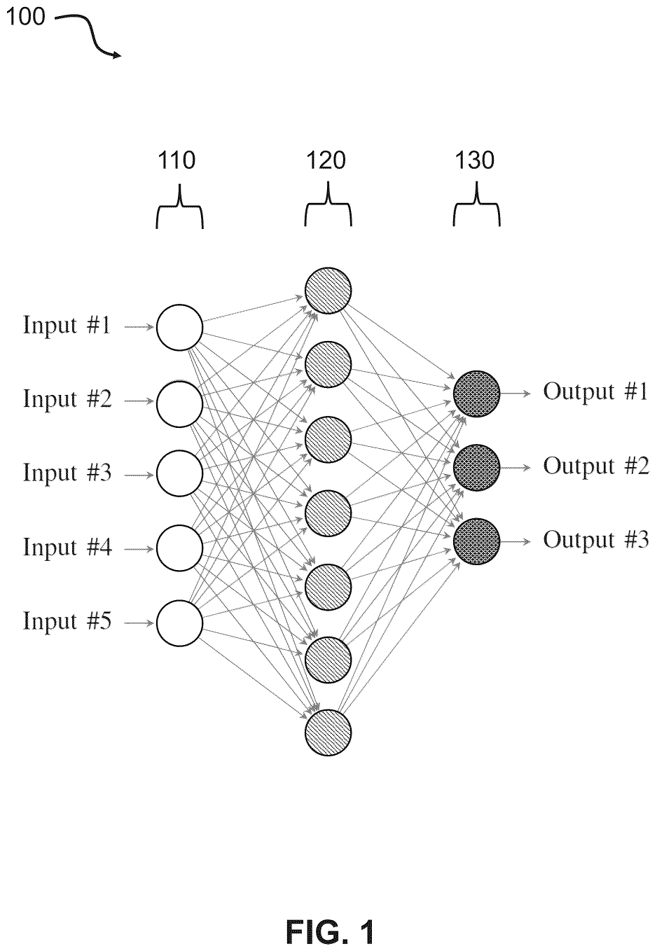

FIG. 1 is a schematic view of an example multilayer perceptron (MLP) network.

In FIG. 1, an example MLP network 100 is illustrated. The example MLP network 100 has a 5-7-3 architecture, in which an input layer 110 has 5 input neurons, a hidden layer 120 has 7 neurons, which may be referred to as “hidden neurons,” and an output layer 130 has 3 output neurons. The input layer 110 may accept input features, in this case, 5 features per data point. The hidden layer 120 may process the input, e.g., using weighted connections and activation functions. For example, the hidden layer 120 may add non-linearity and learning capacity to the network. The output layer 130 may produce a final output, which may be used for multi-class classification, in this case, with 3 possible classes. The output layer 130 may use softmax activation to convert outputs into probabilities. While the example MLP network 100 is illustrated as having a 5-7-3 architecture in a single hidden layer feedforward network (SLFN), example embodiments are not limited thereto. For example, other numbers of neurons may be in each layer and/or the MLP network may be a multilayer feedforward network (MLFN).

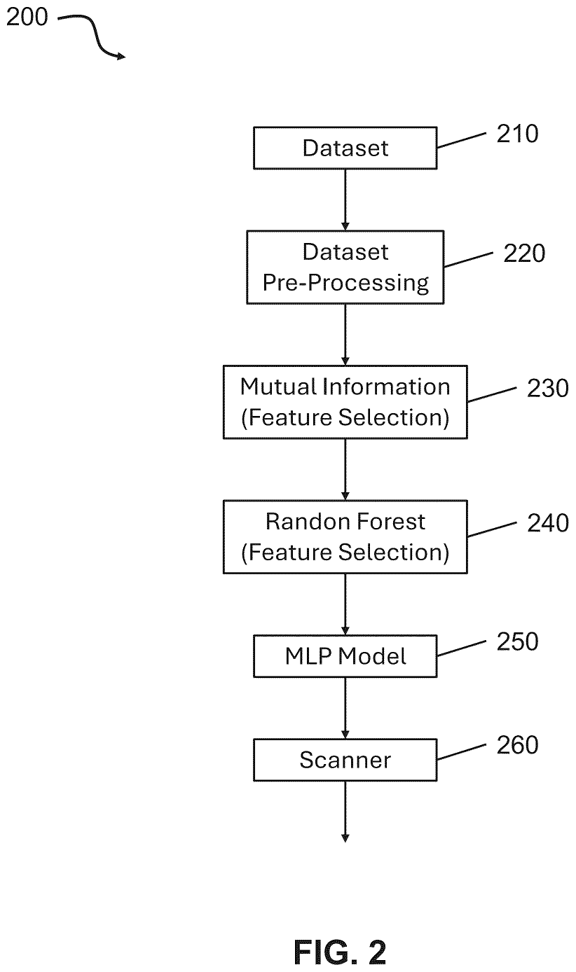

FIG. 2 is a flowchart for a workflow according to an example embodiment of the present disclosure.

FIG. 2 shows an example workflow 200 for generating a model with an optimal number of hidden nodes. The example workflow 200 illustrated in FIG. 2 determines the optimal number of hidden neurons for an MLP neural network model. In the example workflow 200, a dataset is received at 210. Then data pre-processing is performed at 220, in which the initial dataset is cleaned and standardized to ensure it is suitable for analysis. Subsequently, feature selection techniques of Mutual Information at 230, and then Random Forest at 240, are applied to choose the most significant features. Using these selected features, multiple MLP neural network models are constructed with numerous topologies, each differing in the number of hidden layer neurons. After assessing the performance of various model configurations, the best-performing ones are selected for further examination at 250. The selection is based on the appropriate performance criteria. A scanning process (“scanner”) is then applied at 260 to select the best (or optimal) number of hidden neurons within the chosen model that produces the best results.

### Experimental Datasets

In the experiments utilizing example embodiments, the inventors employed seven classification datasets obtained from the UCI Machine Learning Repository and KAGGLE®. These datasets were categorized into binary and multivariate types. The binary datasets included breast cancer detection, heart disease, raisin classification, and credit card fraud detection. The multivariate classification datasets included Iris, Fetal Health, and Balance Scale.

### Data Pre-Processing

During the data preparation (pre-processing) phase, example embodiments may utilize various techniques to refine and optimize the dataset for model comprehension. An initial step may include addressing missing values, for example, either rows containing insignificant missing data may be eliminated or these gaps may be imputed using statistical measures like mean or median. Subsequently, any duplicate records may be identified and removed from the dataset to ensure data integrity. Following this, standardization may be applied, e.g., using Equation 1 below, to all features, excluding a target feature (e.g., target column), which may standardize the data to have a mean of 0 and a standard deviation of 1.

$$z = \frac{x - μ}{σ} \qquad [ Equation 1 ]$$

In Equation 1, x is an individual data point, μ is a mean of a feature, ρ is the standard deviation of the feature, and z is a standardized value.

For categorical variables, example embodiments may employ label encoding to transform the categorical variables into a numerical format, making the categorical variables suitable for model processing. These pre-processing steps are important for enhancing the dataset's quality and ensuring its compatibility with machine learning models.

### Feature Selection

In example embodiments, the pre-processed dataset may undergo a hybrid feature selection process, for example, combining Filter and Embedded techniques. Initially, for the Filter technique, a Mutual Information technique may be used to select the features, in which mutual information values between each feature and the target variable are calculated, e.g., using Equation 2 below, in which p(x,y) is the joint probability distribution of X and Y, p(x), p(y) are marginal probabilities of X and Y respectively.

$$I ( X ; Y ) = {\sum }_{x ∈ X} {\sum }_{y ∈ Y} p ( x , y ) log ( \frac{p ( x , y )}{p ( x ) p ( y )} ) \qquad [ Equation 2 ]$$

These information values may be ranked in descending order of importance. A cumulative sum of these scores may be computed to track the information captured by top-ranked features, e.g., using Equation 3 below. Features collectively accounting for 95% of the total mutual information may be retained, while less informative ones may be eliminated.

$${S}_{k} = {\sum }_{i = 1}^{k} {I}_{i} \qquad [ Equation 3 ]$$

In Equation 3, Sₖ is the cumulative sum of the mutual information values up to the k^{th} feature, and Iᵢ is the mutual information score for the i^{th} feature.

Following this initial feature reduction, the Embedded technique may employ a Random Forest (RF) classifier model. The dataset may be split into training and testing sets, for example, at an 80:20 ratio. An RF classifier model, for example, with 100 decision trees, may be trained on the training data. Post-training, the RF model's computed feature importance (I_{f}) of each individual feature may be extracted, indicating each feature's predictive contribution, for example, in accordance with Equation 4 below.

$${I}_{f ,} f = 1 , 2 , … , n \qquad [ Equation 4 ]$$

The mean importance score (Iₘₑₐₙ) may be calculated, for example, by using formula shown in Equation 5 below, and only features exceeding this threshold may be selected for subsequent analysis.

$${I}_{mean} = \frac{1}{n} {\sum }_{f = 1}^{n} {I}_{f} \qquad [ Equation 5 ]$$

This two-stage approach effectively combines statistical relevance (e.g., Filter technique) with model-based feature importance (e.g., Embedded technique) to identify the most important predictors for the classification task.

### MLP Model

The MLP neural network model may be constructed to train and evaluate the dataset, exploring various hidden neuron configurations to determine the optimal model architecture. The disclosed technique may encompass several steps, including model training, evaluation, and an early stopping mechanism, e.g., based on the F1 score to prevent overfitting. The F1 score is a metric used to evaluate the performance of a classification model, especially when the classes are imbalanced. It combines two other metrics: precision, e.g., how many of the predicted positive cases were actually positive; and recall (or sensitivity), e.g., how many of the actual positive cases were correctly predicted.

The model architecture may be dynamically selected based on the target feature's categories. For multi-class classification, a Categorical Model may be employed, which may include a hidden layer with Rectified Linear Unit (ReLU) activation and an output layer with softmax activation, in which the number of output neurons matches the unique class count. Conversely, for binary classification, a Binary Model may be used, which may include a hidden layer with ReLU activation and an output layer with a single neuron using sigmoid activation. The MLP model may include input, hidden, and output layers. The input layer's neuron count may equal the feature count, while the output layer's neuron count may match the unique class count in the target column. To determine the optimal hidden layer configuration, the number of hidden neurons may vary, for example, from 1 to twice the input feature count. For each hidden neuron configuration, the model may be trained, and performance metrics may be tracked. The selected model may undergo 10-fold cross-validation, e.g., using the same generated weights and biases in each fold. Training may occur, for example, over at least 1000 epochs, e.g., using the Adam optimizer, with cross-entropy loss for multi-class problems or binary cross-entropy loss for binary classifications. Performance metrics, including accuracy, precision, recall, and F1 score (e.g., Equations 6-9 below, respectively), may be recorded for each fold and averaged across all folds for each model structure. An early stopping mechanism may be triggered if the F1 score fails to improve by at least 0.5% over five consecutive iterations, which may mitigate overfitting and reduce unnecessary computation. The resulting performance metrics, along with their corresponding hidden neuron counts, may then be passed to a scanner to implement a Scanner technique for the final selection of the optimal number of hidden neurons, thus refining the MLP model's architecture for optimal performance.

$$Accuracy = \frac{TP + TN}{TP + TN + FP + FN} \qquad [ Equation 6 ]$$

$$Precision = \frac{TP}{TP + FP} \qquad [ Equation 7 ]$$

### Automated Search for Optimal Hidden Neuron Count (Scanner)

To determine the optimal number of hidden neurons, example embodiments may implement an automated Scanner technique, for example, utilizing a predefined accuracy threshold. This technique iterates through the performance metrics obtained from the previous step, particularly focusing on the accuracy associated with each hidden neuron configuration. The process may begin by initializing the “best accuracy” to zero (“0”) and the “optimal hidden neuron configuration” as “undefined.” Subsequently, the Scanner technique may systematically evaluate each experimental result, which may include the number of hidden neurons and its corresponding accuracy. For each configuration, the Scanner technique may compare the current accuracy against the previously recorded best accuracy. A significant feature of this approach is the implementation of a threshold mechanism. The Scanner technique may update the best hidden neuron configuration and highest accuracy only when the current accuracy surpasses the previous best by a specified margin (for example, with a default set to 2%). This threshold may prevent frequent updates based on marginal improvements, ensuring that only configurations demonstrating substantial accuracy gains may be considered. Upon completing the evaluation of all results, the Scanner technique may identify and return two key pieces of information: the optimal number of hidden neurons that yielded the best performance, and the highest accuracy achieved. This methodical and automated approach may enable the selection of a neural network architecture that balances complexity with performance, optimizing the model's efficacy for the given classification task.

### Experimental Results

In this section, the experimental setup and results of the inventors' study is presented. The inventors experimented with various neuron configurations on multiple classification datasets from the UCI machine learning repository, evaluating the model performance based on accuracy and F1 score. To find the optimal network, the inventors pre-processed the datasets, then used feature selection methods. Then, finally, the MLP model was used on the datasets. The inventors implemented different feature selection methods and compared them using the final MLP framework. The optimal number of neurons in the hidden layer was automatically calculated within the MLP framework, resulting in improved performance and the best possible accuracy for the given dataset.

In this experiment, the inventors used seven classification datasets from UCI Machine Learning repository. They were Iris, Balance Scale, Breast Cancer Detection, Heart Disease, Fetal Health, Credit Card fraud detection, and Raisin.

Table 1 below shows a number of hidden neurons and accuracy of the model without feature selection in different datasets. Table 1 reports the evaluation results for all seven datasets without applying feature selection techniques. Table 1 provides key information for each dataset, including the total number of input features utilized in the model and the optimal number of hidden neurons determined during the training process. Additionally, Table 1 presents the best accuracy achieved for each dataset under these configurations. This comprehensive overview allows for a clear comparison of model performance across different datasets, highlighting the relationship between input complexity, hidden layer architecture, and classification accuracy.

TABLE 1

| Dataset | # Input Features | # Hidden Neurons | Accuracy (%) |
|---|---|---|---|
| Iris | 4 | 4 | 96.67 |
| Balance | 4 | 4 | 89.21 |
| Breast Cancer | 30 | 4 | 92.42 |
| Heart | 13 | 2 | 84.15 |
| Fetal Heath | 21 | 6 | 89.32 |
| Credit Card | 23 | 4 | 81.94 |
| Raisin | 7 | 3 | 86.56 |

### Mutual Information Filter Technique

Table 2 below shows Feature Selection using a Mutual Information technique. Table 2 tabulates the outcomes of applying mutual information for feature selection across seven diverse datasets. Table 2 provides a comprehensive overview, detailing the initial feature count, the reduced number of features post-application of mutual information, the resulting model accuracy, and the optimal number of hidden neurons for each dataset. The implementation of Mutual Information as a feature selection technique led to notable improvements in model performance compared to pre-selection results. Across all datasets, the number of input features was successfully reduced, enhancing efficiency while maintaining or improving accuracy. For instance, the Breast Cancer dataset saw a reduction from 30 to 21 features, yet still achieved a high accuracy of 92.89%. Similarly, the Fetal Health dataset's features were condensed from 21 to 15, yielding an accuracy of 88.38%. These results underscore the effectiveness of the Mutual Information technique in eliminating less relevant features. The Mutual Information technique's success is further evidenced by the improved or consistent accuracies across various datasets. Notable examples include the Iris dataset, which achieved 93.86% accuracy, and the Heart dataset, reaching 84.8% accuracy.

TABLE 2

| | Input | Features | Accuracy | # Hidden |
|---|---|---|---|---|
| Dataset | Total | selected | (%) | Neurons |
| Iris | 4 | 3 | 93.86 | 3 |
| Balance | 4 | 4 | 89.12 | 3 |
| Breast Cancer | 30 | 21 | 92.89 | 2 |
| Heart | 13 | 8 | 84.80 | 2 |
| Fetal Health | 21 | 15 | 88.38 | 5 |
| Credit Card | 23 | 17 | 81.76 | 2 |
| Raisin | 7 | 5 | 85.33 | 2 |

### Hybrid Technique

Table 3 below shows Feature Selection using both of a Mutual Information technique and a Random Forest technique. Table 3 tabulates the impact of the disclosed hybrid feature selection technique, which integrates mutual information and random forest techniques, across all seven datasets. Table 3 provides a detailed comparison of model performance before and after feature selection. The results demonstrate the disclosed technique's efficacy in dimensionality reduction while preserving or enhancing model performance. For the Iris dataset, features were reduced from 4 to 2, achieving 95.95% accuracy with 3 hidden neurons. Similarly, for the Breast Cancer dataset, features decreased from 30 to 6, reaching 95.07% accuracy with 2 hidden neurons. Similar patterns of feature reduction and performance optimization were observed across all datasets, underscoring the effectiveness of the disclosed hybrid approach in streamlining model inputs while maintaining high classification accuracy. Table 3 serves as a concise yet comprehensive overview of the disclosed Feature Selection technique's impact on model architecture and performance across diverse datasets.

TABLE 3

| | Input | Features | Accuracy | # Hidden |
|---|---|---|---|---|
| Dataset | Total | Selected | (%) | Neurons |
| Iris | 4 | 2 | 95.95 | 3 |
| Balance | 4 | 2 | 70.10 | 1 |
| Breast Cancer | 30 | 6 | 95.07 | 2 |
| Heart | 13 | 5 | 81.49 | 2 |
| Fetal Health | 21 | 4 | 87.23 | 3 |
| Credit Card | 23 | 11 | 83.76 | 1 |
| Raisin | 7 | 2 | 85.78 | 1 |

### Fetal Health Classification Experiment

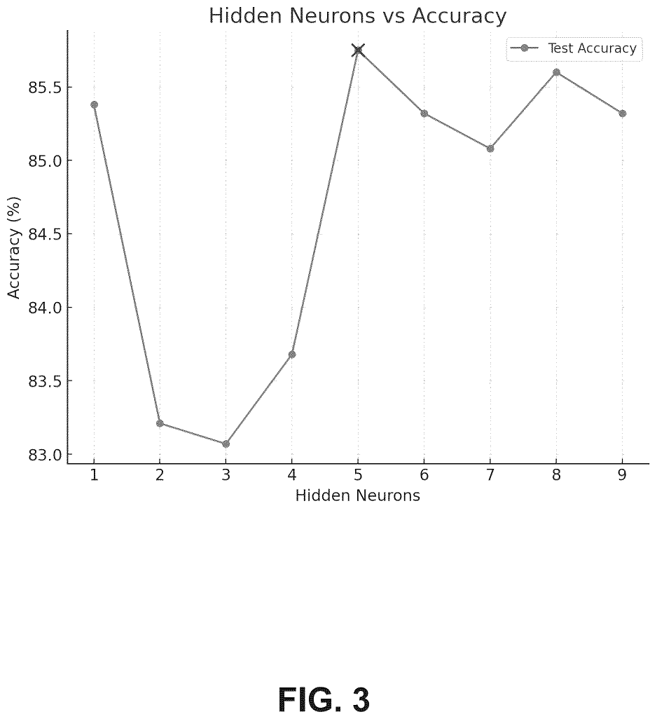

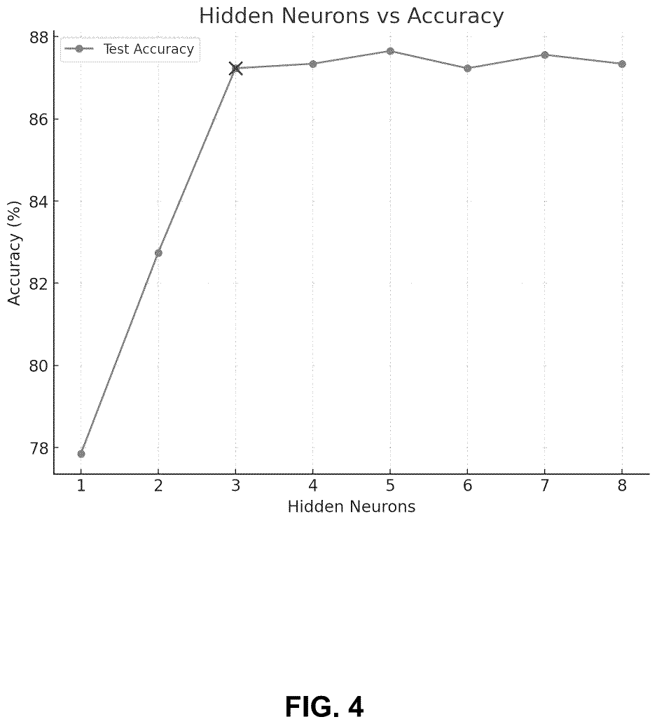

FIGS. 3 and 4 are graphs of experimental results using a Fetal Health dataset.

The Fetal Health dataset is a classification-based dataset that was used to train and test the MLP model for the task of finding the optimal hidden neurons by classifying fetal health to prevent child and maternal mortality. The dataset contains 2126 samples, with 1655 samples as normal, 295 samples as suspect, and 176 samples as pathological. Each sample is described by 21 features, which are measurements of fetal movement, uterine contractions, accelerations, and baseline value.

FIG. 3 is a graph showing experimental results using the Fetal Health dataset comparing the number of Hidden Neurons to an Accuracy percentage after applying the Mutual Information technique. FIG. 3 shows that the number of neurons in the hidden layer in the MLP network affects the performance (accuracy) of the model after applying the mutual information feature selection method. Initially, with 1 hidden neuron, the model achieved an accuracy of 85.38%, but as the number of hidden neurons increased to 2 and 3, the accuracy dropped to 83.21% and 83.07%, respectively, indicating a potential overfitting or underfitting issue. However, as the number of hidden neurons increased further, the accuracy started to improve, with the highest accuracy of 85.75% being achieved at 5 hidden neurons (indicated in FIG. 3 as an ‘X’ over the Test Accuracy indication at 5 neurons). Beyond 5 hidden neurons, the accuracy remained relatively stable, but fluctuated slightly. Therefore, selecting 5 hidden neurons was the best choice for the optimal number of hidden neurons using the Mutual Information Feature Selection technique.

FIG. 4 is a graph showing experimental results using the Fetal Health dataset comparing the number of Hidden Neurons to an Accuracy percentage after applying both of the Mutual Information technique and the Random Forest technique. FIG. 4 shows that the number of neurons in the hidden layer in the MLP network affects the performance (accuracy) of the model after applying the hybrid Feature Selection technique by using a Mutual Information Feature Selection technique first and then using a Random Forest technique to select the features. Initially, with one hidden neuron, the model achieved an accuracy of 77.85%, but as the number of hidden neurons increased, the performance of the model also increased. For example, at 3 hidden neurons, it can be seen that the model achieved 87.23%. Beyond increasing the number of hidden neurons, there was no significant change in accuracy. Therefore, the experiment achieved optimal performance by using 3 hidden neurons.

Comparison with Prior Work (Breast Cancer Dataset)

Table 4 below shows a comparison of predicted optimal number of hidden neurons using other techniques. Table 4 presents a comparative analysis of various techniques, focusing on the number of hidden neurons and corresponding accuracies for the Breast Cancer Detection dataset. This comparison provides context for the performance of models generated in accordance with example embodiments of the present disclosure. In experiments, using the disclosed hybrid technique, the inventors achieved a notable accuracy of 95.07% using a configuration with 2 hidden neurons for the Breast Cancer dataset. Table 4 allows for a direct evaluation of the disclosed example model's efficiency and effectiveness relative to other established techniques in the field of breast cancer detection.

TABLE 4

| | # Original | # Final | # Hidden | Accuracy |
|---|---|---|---|---|
| Author | Features | Features | Neurons | (%) |
| Study #1 | 30 | 30 | 41 | 89.17 |
| Study #2 | 30 | 8 | 20 | 97.4 |
| Present | 30 | 6 | 2 | 95.07 |

Example embodiments provide an innovative approach to optimize the architecture of MLP models for specific datasets. The disclosed framework combines sophisticated hybrid feature selection techniques to identify the most relevant input features, while also determining the ideal number of neurons in the hidden layers. To validate the effectiveness of the disclosed methodology, the inventors conducted extensive experiments using a diverse range of classification datasets. These experimental datasets drew from both the UCI Machine Learning Repository and KAGGLE® datasets, demonstrating the versatility and robustness of the disclosed framework across various domains and data types. The results highlight the strength of example embodiments in reducing dimensionality while maintaining or improving model accuracy. For instance, on the Iris dataset, the number of features was reduced from 4 to 2, resulting in 95.95% accuracy with 3 hidden neurons. Similarly, for the Breast Cancer dataset, the feature set was reduced from 30 to 6, achieving 95.07% accuracy with 2 hidden neurons. The experimental findings provide a comprehensive perspective on how feature selection impacts model architecture and performance across diverse datasets.

Example embodiments may yield a technical effect of enhancing the operational efficiency, computational speed, and/or cost-effectiveness of hardware and embedded systems. For example, the optimization of the number of hidden neurons within artificial neural networks can significantly reduce energy consumption, alleviate memory constraints, and support real-time processing requirements. By reducing or minimizing the number of hidden neurons, the system may require fewer transistors and floating-point operations (FLOPs), thereby decreasing memory usage and power demands while concurrently improving inference speed. This reduction in redundant or non-contributory hidden neurons not only lowers computational overhead, but also enables deployment on resource-constrained platforms, such as edge devices or embedded systems, where efficiency is paramount. Furthermore, such optimization may lead to a reduction in model size without compromising—and in some cases enhancing-predictive accuracy, through the elimination of superfluous connections, neurons, and/or weights. Consequently, when new input data is processed by a model configured with an optimized number of hidden neurons, as determined by techniques disclosed in example embodiments, the computing system may exhibit improved performance characteristics relative to conventional approaches. These embodiments thus facilitate the development of streamlined, resource-efficient artificial intelligence models suitable for a wide range of practical applications.

Example embodiments may be implemented in automated machine learning platforms and neural network optimization software, thereby reducing the computational overhead and time required for model architecture design while improving classification accuracy across diverse datasets. For example, example embodiments may provide an automated system for determining optimal hidden neuron configurations in multilayer perceptrons, which eliminates the need for manual trial-and-error approaches and enables rapid deployment of efficient neural networks in production environments.

Example embodiments may find application in edge computing devices and Internet of Things (IOT) systems in which computational resources are limited. By automatically reducing both the number of input features and hidden neurons while maintaining high accuracy, example embodiments may enable deployment of machine learning models on resource-constrained hardware platforms, such as embedded processors, mobile devices, and edge computing nodes.

Example embodiments may be integrated into cloud-based machine learning services and automated model optimization platforms, providing software-as-a-service solutions for enterprises seeking to optimize their neural network architectures without requiring specialized expertise in neural network design. For example, in the healthcare industry, example embodiments may be applied to medical diagnostic systems where both accuracy and computational efficiency are critical. The automated optimization of neural networks for medical classification tasks, such as the demonstrated Breast Cancer detection achieving 95.07% accuracy with only 2 hidden neurons, enables deployment of reliable diagnostic tools in clinical settings with varying computational capabilities. Example embodiments may be commercialized as a software development kit or application programming interface that integrates with existing machine learning frameworks, allowing developers to automatically optimize their multilayer perceptron models for specific classification tasks across industries including finance, manufacturing, telecommunications, and cybersecurity.

Example embodiments may provide an automated system for optimizing multilayer perceptron neural networks that determines the optimal number of hidden neurons while simultaneously reducing input features for classification tasks. Example embodiments may include a hybrid feature selection process that combines Mutual Information filtering with Random Forest embedded techniques, a multilayer perceptron model with dynamically configurable hidden layer architecture, and a scanner technique that identifies optimal neuron configurations based on performance thresholds.

In addition, example embodiments may incorporate k-fold cross-validation with consistent weight initialization across all folds, an early stopping mechanism that monitors F1-score improvements to prevent overfitting, and automated pre-processing capabilities including standardization and categorical encoding. More so, the scanner technique evaluates multiple neuron configurations and selects architectures that exceed predefined accuracy improvement thresholds, e.g., 2%, ensuring that only configurations with substantial performance gains are considered. The integration of feature reduction and neuron optimization enables deployment of efficient neural networks that achieve high accuracy with minimal computational resources, as demonstrated by achieving 95.07% accuracy on Breast Cancer classification using only 2 hidden neurons with 6 input features.

In the context of optimizing neural network architectures for classification tasks, existing methods typically rely on manual trial-and-error approaches or computationally expensive grid search techniques to determine the optimal number of hidden neurons. These conventional approaches often require extensive computational resources and specialized expertise, making them impractical for rapid deployment in production environments or resource-constrained systems. Although such traditional optimization methods can achieve satisfactory results, they are time-consuming, require significant computational overhead, and often result in over-engineered networks with excessive parameters that consume unnecessary resources while providing minimal performance improvements.

Example embodiments may provide an automated system for optimizing multilayer perceptron architectures that eliminates the need for manual configuration and reduces computational requirements while maintaining or improving classification accuracy across diverse datasets. Example embodiments may provide an automated optimization system that combines hybrid feature selection with dynamic neuron configuration, enabling the deployment of efficient neural networks that achieve high accuracy with minimal computational resources, as demonstrated by the Breast Cancer classification results achieving 95.07% accuracy using only 2 hidden neurons, as compared to traditional methods requiring 20-41 hidden neurons for similar performance levels.

There are several challenges and technical problems that persist in the previous methods related to neural network optimization. For one, conventional methods for determining optimal hidden neuron configurations typically rely on computationally expensive trial-and-error approaches or grid search techniques that require extensive computational resources and specialized expertise, making them impractical for rapid deployment in production environments. Furthermore, existing optimization methods often result in over-engineered networks with excessive parameters that consume unnecessary computational resources while providing minimal performance improvements, as evidenced by traditional approaches requiring 20-41 hidden neurons to achieve similar accuracy levels that can be obtained with significantly fewer neurons. Additionally, most conventional methods fail to integrate feature selection with neuron optimization in a unified framework, missing the opportunity to simultaneously reduce both input dimensionality and network complexity. The lack of automated pre-processing and standardized cross-validation procedures in existing approaches leads to inconsistent results and poor generalization performance across different datasets. Moreover, conventional methods do not incorporate intelligent stopping mechanisms to prevent overfitting, often resulting in models that memorize training data, but perform poorly on unseen or new examples. Lastly, the absence of threshold-based selection criteria in existing optimization techniques leads to acceptance of marginal improvements that do not justify increased computational complexity. These unresolved issues and technical problems underscore the pressing demand for an automated system that can efficiently optimize both feature selection and hidden neuron configuration while maintaining high classification accuracy with minimal computational overhead.

There are several technical advantages of the automated hidden neuron optimization system of the present disclosure. First, the integration of hybrid feature selection methods combining Mutual Information filtering with Random Forest embedded techniques substantially reduces both input dimensionality and computational complexity while maintaining or improving classification accuracy. This dual optimization approach enables example embodiments to achieve superior performance with significantly fewer resources, as demonstrated by achieving 95.07% accuracy on Breast Cancer classification using only 2 hidden neurons compared to traditional methods requiring 20-41 hidden neurons for similar performance levels. Additionally, in example embodiments, the automated k-fold cross-validation with consistent weight initialization across all folds ensures reproducible and reliable performance metrics, eliminating the variability inherent in conventional optimization approaches. The intelligent early stopping mechanism based on F1 score monitoring may prevent overfitting while reducing unnecessary computational overhead, for example, automatically terminating training when performance improvements plateau.

Furthermore, the threshold-based scanner technique may ensure that only architectures demonstrating substantial performance gains exceeding predefined improvement thresholds are selected, preventing acceptance of marginal improvements that do not justify increased complexity. The automated pre-processing capabilities of example embodiments, including standardization and categorical encoding, may eliminate the need for manual data preparation expertise while ensuring optimal data quality for model training. The unified framework's ability to simultaneously optimize feature selection and neuron configuration may provide a comprehensive solution that adapts to diverse classification tasks across multiple domains, from medical diagnosis to fraud detection, without requiring specialized neural network design knowledge. These technical advantages collectively contribute to a state-of-the-art automated optimization solution that delivers efficient, accurate, and resource-conscious neural network architectures suitable for deployment in resource-constrained environments, such as edge computing devices and IoT systems.

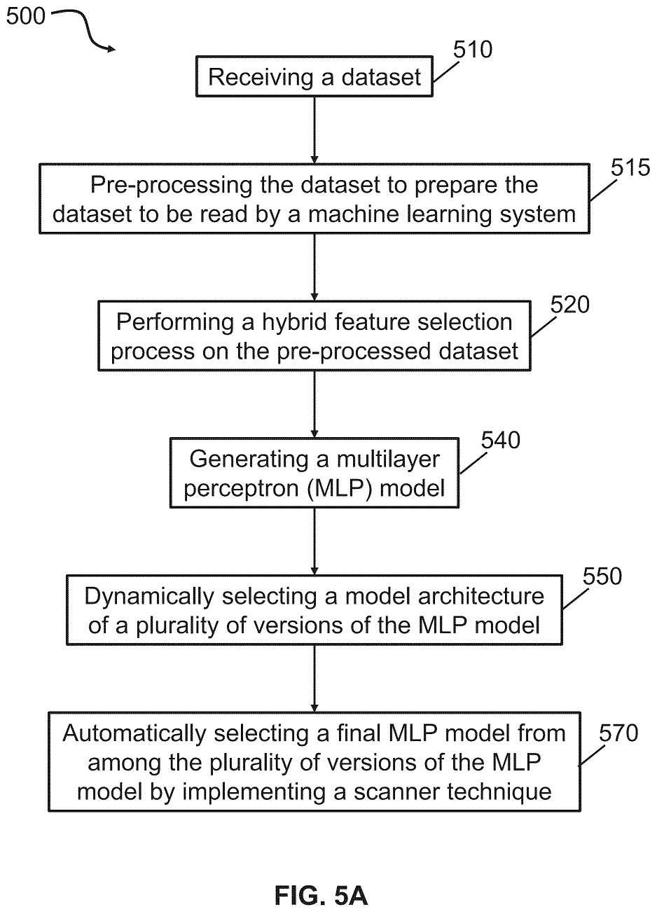

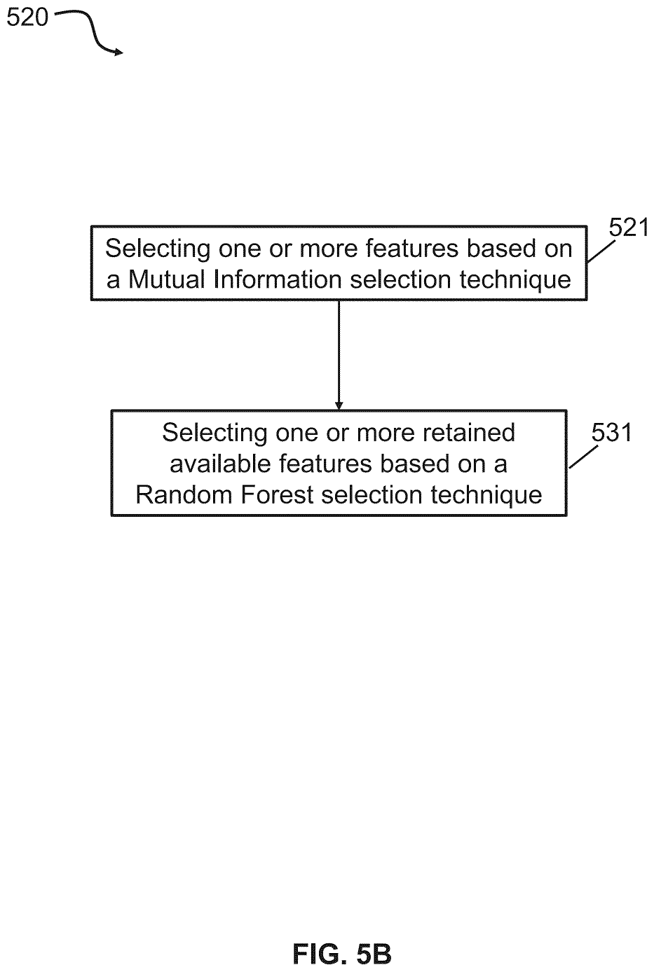

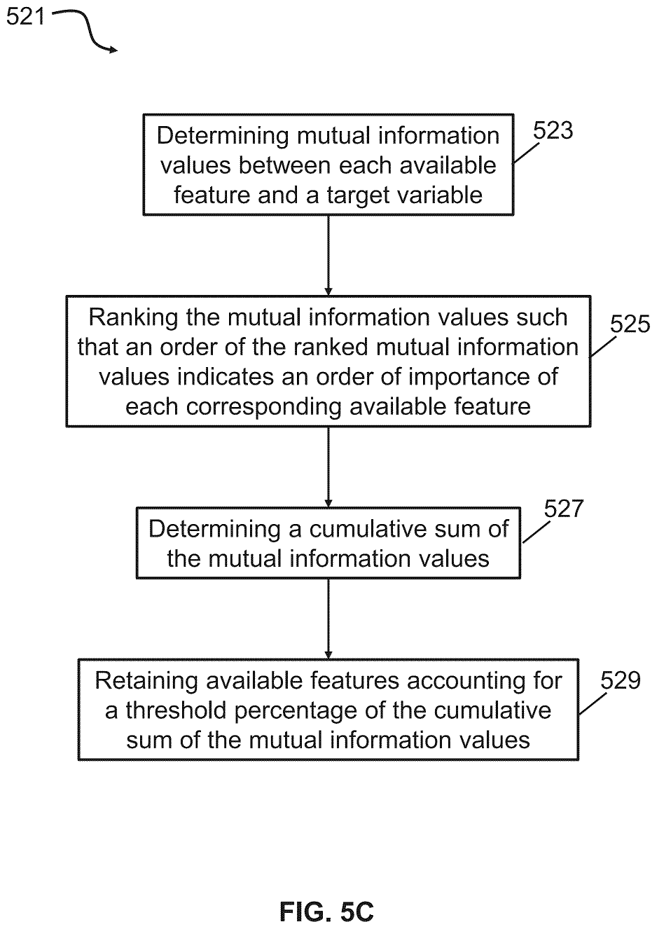

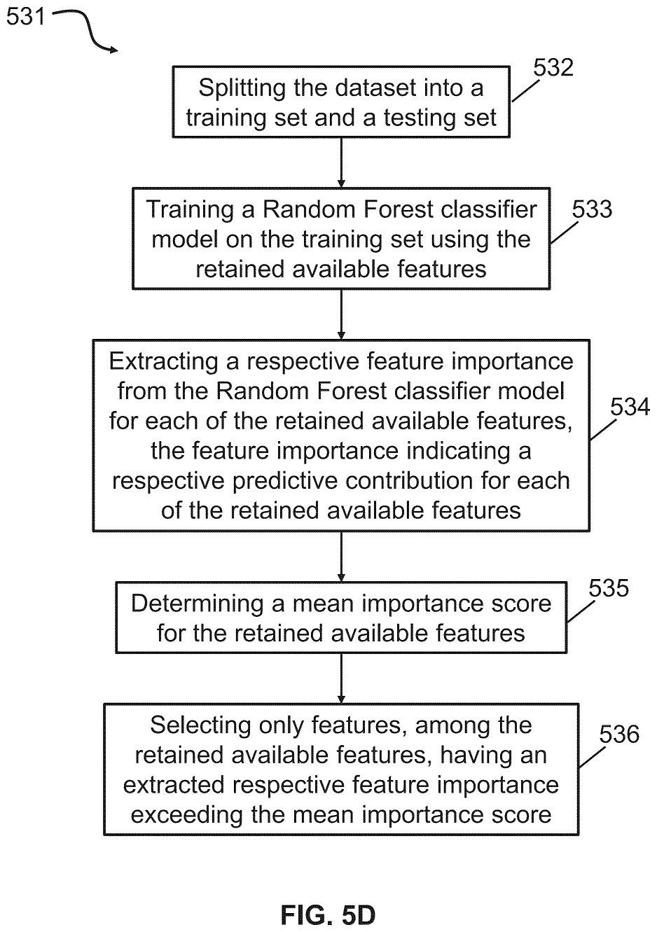

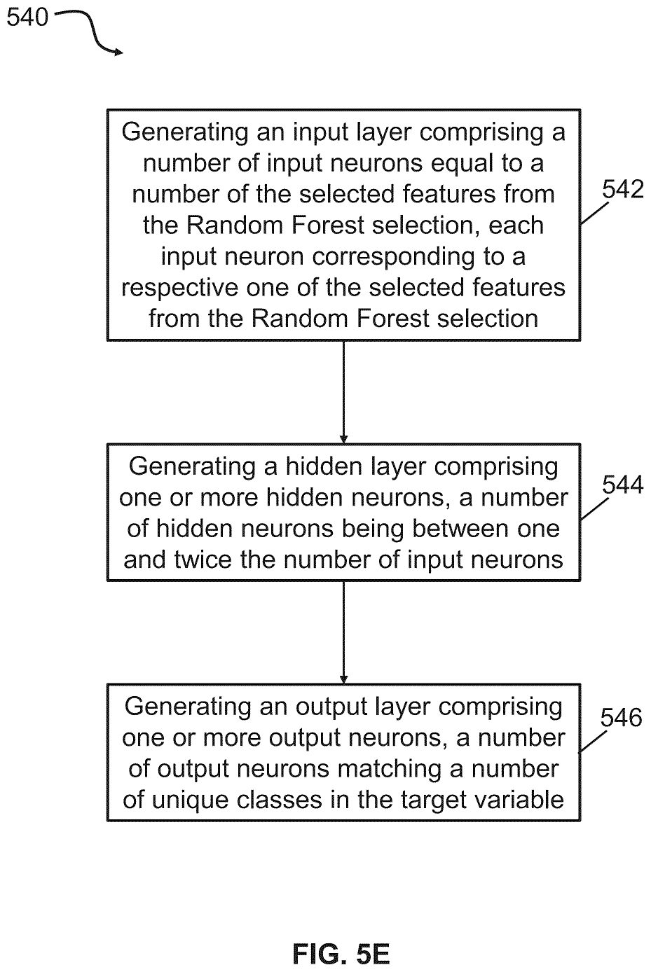

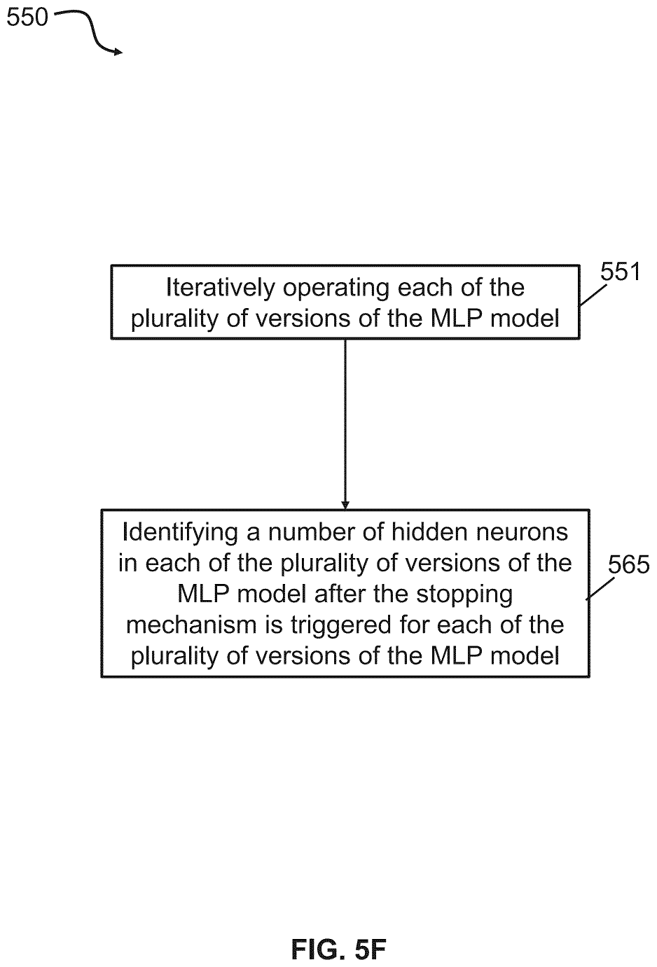

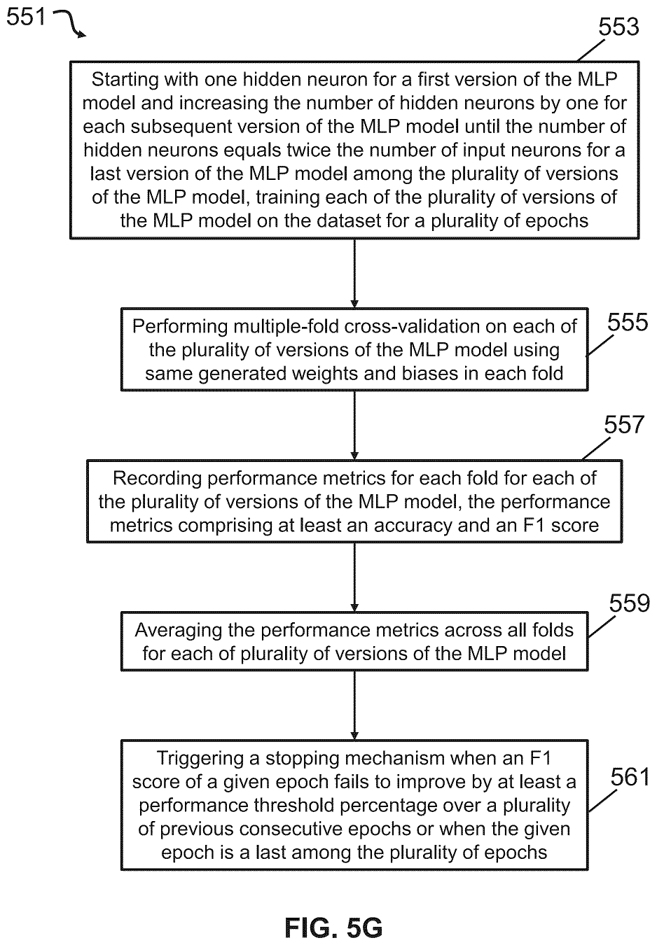

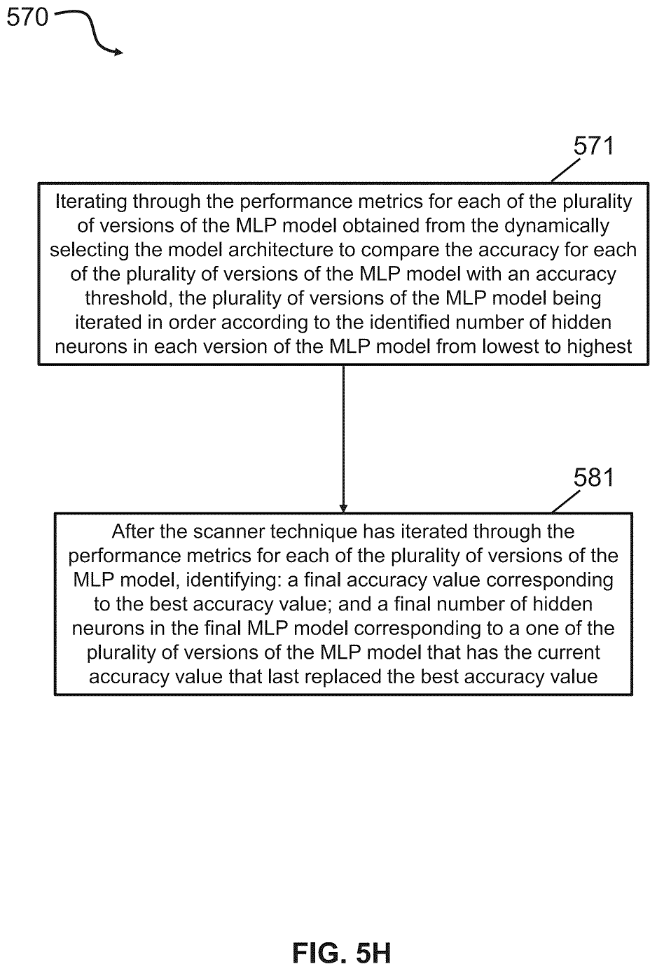

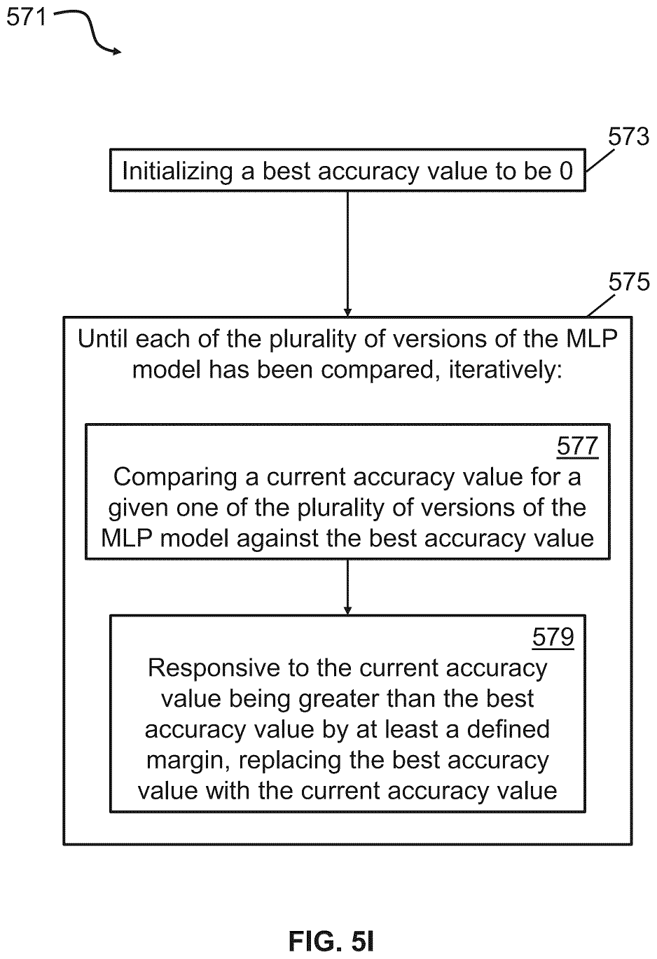

FIGS. 5A-5I are flowcharts for an example method.

In FIG. 5A, an example method 500 may include, at 510, receiving a dataset. The example method 500 may further include, at 515, pre-processing the dataset to prepare the dataset to be read by a machine learning system. The example method 500 may further include, at 520, performing a hybrid feature selection process on the pre-processed dataset. The example method 500 may further include, at 540, generating a multilayer perceptron (MLP) model. The example method 500 may further include, at 550, dynamically selecting a model architecture of a plurality of versions of the MLP model. The example method 500 may further include, at 570, automatically selecting a final MLP model from among the plurality of versions of the MLP model by implementing a scanner technique.

As shown in FIG. 5B, the performing the hybrid feature selection process of 520 may include, at 521, selecting one or more features based on a Mutual Information selection technique. The performing the hybrid feature selection process of 520 may further include, at 531, selecting one or more retained available features based on a Random Forest selection technique.

As shown in FIG. 5C, the selecting one or more features based on the Mutual Information selection technique of 521 may include, at 523, determining mutual information values between each available feature and a target variable. The selecting one or more features based on a Mutual Information selection technique of 521 may further include, at 525, ranking the mutual information values such that an order of the ranked mutual information values indicates an order of importance of each corresponding available feature, The selecting one or more features based on a Mutual Information selection technique of 521 may further include, at 527, determining a cumulative sum of the mutual information values. The selecting one or more features based on a Mutual Information selection technique of 521 may further include, at 529, retaining available features accounting for a threshold percentage of the cumulative sum of the mutual information values.

As shown in FIG. 5D, the selecting one or more of the retained available features based on the Random Forest selection technique of 531 may include, at 532, splitting the dataset into a training set and a testing set. The selecting one or more of the retained available features based on a Random Forest selection technique of 531 may further include, at 533, training a Random Forest classifier model on the training set using the retained available features. The selecting one or more of the retained available features based on a Random Forest selection technique of 531 may further include, at 534, extracting a respective feature importance from the Random Forest classifier model for each of the retained available features, the feature importance indicating a respective predictive contribution for each of the retained available features. The selecting one or more of the retained available features based on a Random Forest selection technique of 531 may further include, at 535, determining a mean importance score for the retained available features. The selecting one or more of the retained available features based on a Random Forest selection technique of 531 may further include, at 536, selecting only features, among the retained available features, having an extracted respective feature importance exceeding the mean importance score.

As shown in FIG. 5E, the generating the MLP model of 540 may include, at 542, generating an input layer comprising a number of input neurons equal to a number of the selected features from the Random Forest selection, each input neuron corresponding to a respective one of the selected features from the Random Forest selection. The generating the MLP model of 540 may further include, at 544, generating a hidden layer comprising one or more hidden neurons, a number of hidden neurons being between one and twice the number of input neurons. The generating the MLP model of 540 may further include, at 546, generating an output layer comprising one or more output neurons, a number of output neurons matching a number of unique classes in the target variable.

As shown in FIG. 5F, the dynamically selecting the model architecture of the plurality of versions of the MLP model 550 may include, at 551, iteratively operating each of the plurality of versions of the MLP model. The dynamically selecting the model architecture of the plurality of versions of the MLP model 550 may further include, at 565, identifying a number of hidden neurons in each of the plurality of versions of the MLP model after the stopping mechanism is triggered for each of the plurality of versions of the MLP model.

As shown in FIG. 5G, the iteratively operating each of the plurality of versions of the MLP model of 551 may include, at 553, starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs. The iteratively operating each of the plurality of versions of the MLP model of 551 may further include, at 555, performing multiple-fold cross-validation on each of the plurality of versions of the MLP model using same generated weights and biases in each fold. The iteratively operating each of the plurality of versions of the MLP model of 551 may further include, at 557, recording performance metrics for each fold for each of the plurality of versions of the MLP model, the performance metrics comprising at least an accuracy and an F1 score. The iteratively operating each of the plurality of versions of the MLP model of 551 may further include, at 559, averaging the performance metrics across all folds for each of plurality of versions of the MLP model. The iteratively operating each of the plurality of versions of the MLP model of 551 may further include, at 561, triggering a stopping mechanism when an F1 score of a given epoch fails to improve by at least a performance threshold percentage over a plurality of previous consecutive epochs or when the given epoch is a last among the plurality of epochs.

As shown in FIG. 5H, the scanner technique of 570 may include, at 571, iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest. The scanner technique of 570 may further include, at 581, after the scanner technique has iterated through the performance metrics for each of the plurality of versions of the MLP model, identifying: a final accuracy value corresponding to the best accuracy value; and a final number of hidden neurons in the final MLP model corresponding to a one of the plurality of versions of the MLP model that has the current accuracy value that last replaced the best accuracy value.

As shown in FIG. 5I, the comparing the accuracy in the scanner technique of 571 may include, at 573, initializing a best accuracy value to be 0. The comparing the accuracy in the scanner technique of 571 may further include, at 575, until each of the plurality of versions of the MLP model has been compared, iteratively: comparing a current accuracy value for a given one of the plurality of versions of the MLP model against the best accuracy value (577), and responsive to the current accuracy value being greater than the best accuracy value by at least a defined margin, replacing the best accuracy value with the current accuracy value (579).

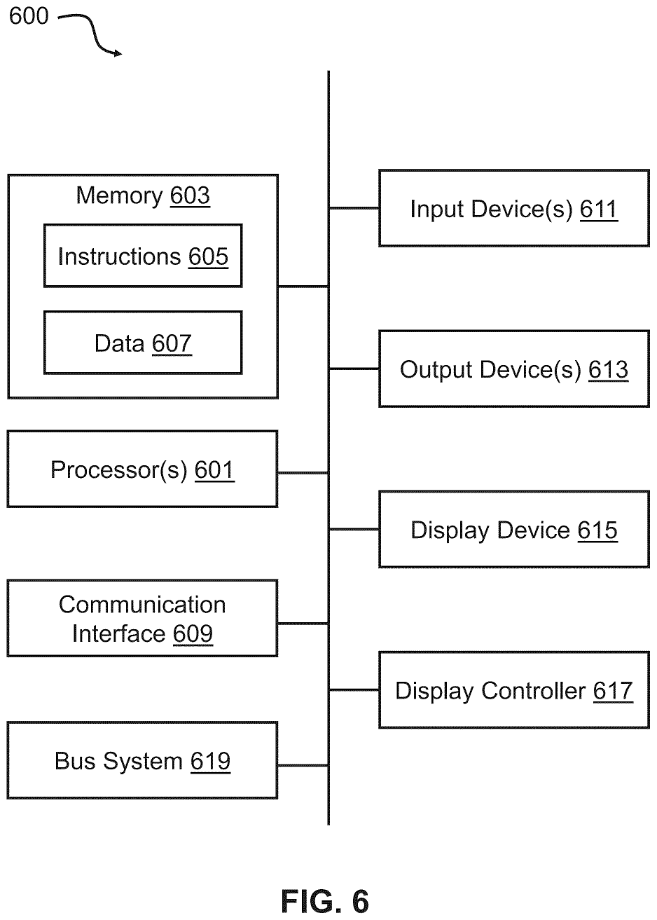

FIG. 6 illustrates certain components that may be included within a computer system according to an example embodiment of the present disclosure.

FIG. 6 illustrates certain components that may be included within a computer system 600, which may be used to control features according to embodiments of the present disclosure, such as the features discussed with reference to FIGS. 1-5. One or more computer systems 600 may be used to implement the various devices, components, and systems described herein.

The computer system 600 includes one or more processors 601. The processor(s) 601 may be a single processor or may include multiple processors and/or sub-processors. The processor(s) 601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor(s) 601 may be referred to as a central processing unit (CPU). Although a single processor(s) 601 is shown in the computer system 600 of FIG. 6, in an alternative configuration, a combination of processors (e.g., an ARM and DSP) could be used. In one or more embodiments, the computer system 600 further includes one or more graphics processing units (GPUs), which can provide processing services related to both entity classification and graph generation.

The computer system 600 also includes memory 603 in electronic communication with the processor(s) 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory device or multiple memory devices.

Instructions 605 and data 607 may be stored in the memory 603. The instructions 605 may be executable by the processor(s) 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor(s) 601. Any of the various examples of data described herein may be among the data 607 that is stored in memory 603 and used during execution of the instructions 605 by the processor(s) 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like, and may be provided in any desired number. At least one display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The following are sections in accordance with at least one embodiment of the present disclosure:
Clause 1: A method, including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an F1 score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.
Clause 2: The method of clause 1, wherein the pre-processing includes data cleaning including: correcting one or more of inconsistencies or errors, and addressing missing information using one or more of imputation or deletion processes.
Clause 3: The method of clause 1, wherein the Random Forest classifier model includes at least 100 decision trees.
Clause 4: The method of clause 1, wherein: a number of the plurality of epochs is ≥1000 epochs, and the training utilizes an Adam optimizer with cross-entropy loss for multi-class problems or binary cross-entropy loss for binary classifications.
Clause 5: The method of clause 1, wherein the performance metrics further include precision and recall.
Clause 6: The method of clause 1, wherein the performance threshold percentage for the stopping mechanism is at least 0.5% over five consecutive epochs.
Clause 7: The method of clause 1, wherein the defined margin is 2%.
Clause 8: The method of clause 1, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.
Clause 9: One or more non-transitory computer-readable media storing instructions that, when executed by at least one processor of a computing system, cause the computing system to perform operations, the operations including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an F1 score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.
Clause 10: The one or more non-transitory computer-readable media of clause 9, wherein the pre-processing includes data cleaning including: correcting one or more of inconsistencies or errors, and addressing missing information using one or more of imputation or deletion processes.
Clause 11: The one or more non-transitory computer-readable media of clause 9, wherein the Random Forest classifier model includes at least 100 decision trees.
Clause 12: The one or more non-transitory computer-readable media of clause 9, wherein: a number of the plurality of epochs is ≥1000 epochs, and the training utilizes an Adam optimizer with cross-entropy loss for multi-class problems or binary cross-entropy loss for binary classifications.
Clause 13: The one or more non-transitory computer-readable media of clause 9, wherein the performance metrics further include precision and recall.
Clause 14: The one or more non-transitory computer-readable media of clause 9, wherein the performance threshold percentage for the stopping mechanism is at least 0.5% over five consecutive epochs.
Clause 15: The one or more non-transitory computer-readable media of clause 9, wherein the defined margin is 2%.
Clause 16: The one or more non-transitory computer-readable media of clause 9, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.
Clause 17: A system, including: one or more processors, and at least one memory including at least one non-transitory computer-readable medium storing instructions that, when executed by at least one of the one or more processors, cause the system to perform operations, the operations including: receiving a dataset, pre-processing the dataset to prepare the dataset to be read by a machine learning system, performing a hybrid feature selection process on the pre-processed dataset, the hybrid feature selection process including: selecting one or more features based on a Mutual Information selection technique including: determining mutual information values between each available feature and a target variable, ranking the mutual information values such that an order of the ranked mutual information values indicates an order of importance of each corresponding available feature, determining a cumulative sum of the mutual information values, and retaining available features accounting for a threshold percentage of the cumulative sum of the mutual information values, and selecting one or more of the retained available features based on a Random Forest selection technique including: splitting the dataset into a training set and a testing set, training a Random Forest classifier model on the training set using the retained available features, extracting a respective feature importance from the Random Forest classifier model for each of the retained available features, the feature importance indicating a respective predictive contribution for each of the retained available features, determining a mean importance score for the retained available features, and selecting only features, among the retained available features, having an extracted respective feature importance exceeding the mean importance score, generating a multilayer perceptron (MLP) model including: generating an input layer including a number of input neurons equal to a number of the selected features from the Random Forest selection, each input neuron corresponding to a respective one of the selected features from the Random Forest selection, generating a hidden layer including one or more hidden neurons, a number of hidden neurons being between one and twice the number of input neurons, and generating an output layer including one or more output neurons, a number of output neurons matching a number of unique classes in the target variable, dynamically selecting a model architecture of a plurality of versions of the MLP model by: iteratively operating each of the plurality of versions of the MLP model, the iteratively operating including: starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs, performing multiple-fold cross-validation on each of the plurality of versions of the MLP model using same generated weights and biases in each fold, recording performance metrics for each fold for each of the plurality of versions of the MLP model, the performance metrics including at least an accuracy and an F1 score, averaging the performance metrics across all folds for each of plurality of versions of the MLP model, and triggering a stopping mechanism when an F1 score of a given epoch fails to improve by at least a performance threshold percentage over a plurality of previous consecutive epochs or when the given epoch is a last among the plurality of epochs, and identifying a number of hidden neurons in each of the plurality of versions of the MLP model after the stopping mechanism is triggered for each of the plurality of versions of the MLP model, and automatically selecting a final MLP model from among the plurality of versions of the MLP model by implementing a scanner technique, the scanner technique including: iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy including: initializing a best accuracy value to be 0, and until each of the plurality of versions of the MLP model has been compared, iteratively: comparing a current accuracy value for a given one of the plurality of versions of the MLP model against the best accuracy value, and responsive to the current accuracy value being greater than the best accuracy value by at least a defined margin, replacing the best accuracy value with the current accuracy value, and after the scanner technique has iterated through the performance metrics for each of the plurality of versions of the MLP model, identifying: a final accuracy value corresponding to the best accuracy value, and a final number of hidden neurons in the final MLP model corresponding to a one of the plurality of versions of the MLP model that has the current accuracy value that last replaced the best accuracy value.
Clause 18: The system of clause 17, wherein the pre-processing includes data cleaning including: correcting one or more of inconsistencies or errors, and addressing missing information using one or more of imputation or deletion processes.
Clause 19: The system of clause 17, wherein the performance threshold percentage for the stopping mechanism is at least 0.5% over five consecutive epochs.
Clause 20: The system of clause 17, wherein the defined margin is 2%.
Clause 21: The system of clause 17, wherein each MLP model includes one of: for multi-class classification, a categorical model including a hidden layer including Rectified Linear Unit (ReLU) activation and an output layer with softmax activation, in which the number of output neurons matches a unique class count, or for binary classification, a binary model including a hidden layer with ReLU activation and an output layer with a single neuron using sigmoid activation.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either wired, wireless, or a combination of wired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about,” “˜”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words “means for” appear together with an associated function. Each addition, deletion, and modification to the embodiments that falls within the meaning and scope of the claims is to be embraced by the claims. Any trademarks mentioned herein are the property of their respective owners. Example embodiments are not limited to any particularly-mentioned products, trademarks, or properties.

The terms “approximately,” “about,” “˜”, and “substantially” as used herein represent an amount close to the stated amount that still performs a desired function or achieves a desired result. For example, the terms “approximately,” “about,” “˜”, and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a dataset;
pre-processing the dataset to prepare the dataset to be read by a machine learning system;
performing a hybrid feature selection process on the pre-processed dataset, the hybrid feature selection process comprising:
selecting one or more features based on a Mutual Information selection technique comprising:
determining mutual information values between each available feature and a target variable;
ranking the mutual information values such that an order of the ranked mutual information values indicates an order of importance of each corresponding available feature;
determining a cumulative sum of the mutual information values; and
retaining available features accounting for a threshold percentage of the cumulative sum of the mutual information values; and
selecting one or more of the retained available features based on a Random Forest selection technique comprising:
splitting the dataset into a training set and a testing set;
training a Random Forest classifier model on the training set using the retained available features;
extracting a respective feature importance from the Random Forest classifier model for each of the retained available features, the feature importance indicating a respective predictive contribution for each of the retained available features;
determining a mean importance score for the retained available features; and
selecting only features, among the retained available features, having an extracted respective feature importance exceeding the mean importance score;
generating a multilayer perceptron (MLP) model comprising:
generating an input layer comprising a number of input neurons equal to a number of the selected features from the Random Forest selection, each input neuron corresponding to a respective one of the selected features from the Random Forest selection;
generating a hidden layer comprising one or more hidden neurons, a number of hidden neurons being between one and twice the number of input neurons; and
generating an output layer comprising one or more output neurons, a number of output neurons matching a number of unique classes in the target variable;
dynamically selecting a model architecture of a plurality of versions of the MLP model by:
iteratively operating each of the plurality of versions of the MLP model, the iteratively operating comprising:
starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs;
performing multiple-fold cross-validation on each of the plurality of versions of the MLP model using same generated weights and biases in each fold;
recording performance metrics for each fold for each of the plurality of versions of the MLP model, the performance metrics comprising at least an accuracy and an F1 score;
averaging the performance metrics across all folds for each of plurality of versions of the MLP model; and
triggering a stopping mechanism when an F1 score of a given epoch fails to improve by at least a performance threshold percentage over a plurality of previous consecutive epochs or when the given epoch is a last among the plurality of epochs; and
identifying a number of hidden neurons in each of the plurality of versions of the MLP model after the stopping mechanism is triggered for each of the plurality of versions of the MLP model; and
automatically selecting a final MLP model from among the plurality of versions of the MLP model by implementing a scanner technique, the scanner technique comprising:
iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy comprising:
initializing a best accuracy value to be 0; and
until each of the plurality of versions of the MLP model has been compared, iteratively:
comparing a current accuracy value for a given one of the plurality of versions of the MLP model against the best accuracy value; and
responsive to the current accuracy value being greater than the best accuracy value by at least a defined margin, replacing the best accuracy value with the current accuracy value; and
after the scanner technique has iterated through the performance metrics for each of the plurality of versions of the MLP model, identifying:
a final accuracy value corresponding to the best accuracy value; and
a final number of hidden neurons in the final MLP model corresponding to a one of the plurality of versions of the MLP model that has the current accuracy value that last replaced the best accuracy value.

2. The method of claim 1, wherein the pre-processing comprises data cleaning comprising:
correcting one or more of inconsistencies or errors; and
addressing missing information using one or more of imputation or deletion processes.

3. The method of claim 1, wherein the Random Forest classifier model comprises at least 100 decision trees.

4. The method of claim 1, wherein:
a number of the plurality of epochs is ≥1000 epochs; and
the training utilizes an Adam optimizer with cross-entropy loss for multi-class problems or binary cross-entropy loss for binary classifications.

5. The method of claim 1, wherein the performance metrics further comprise precision and recall.

6. The method of claim 1, wherein the performance threshold percentage for the stopping mechanism is at least 0.5% over five consecutive epochs.

7. The method of claim 1, wherein the defined margin is 2%.

8. The method of claim 1, wherein each MLP model comprises one of:
for multi-class classification, a categorical model comprising a hidden layer comprising Rectified Linear Unit (ReLU) activation and an output layer with softmax activation, in which the number of output neurons matches a unique class count; or
for binary classification, a binary model comprising a hidden layer with ReLU activation and an output layer with a single neuron using sigmoid activation.

9. One or more non-transitory computer-readable media storing instructions that, when executed by at least one processor of a computing system, cause the computing system to perform operations, the operations comprising:
receiving a dataset;
pre-processing the dataset to prepare the dataset to be read by a machine learning system;
performing a hybrid feature selection process on the pre-processed dataset, the hybrid feature selection process comprising:
selecting one or more features based on a Mutual Information selection technique comprising:
determining mutual information values between each available feature and a target variable;
ranking the mutual information values such that an order of the ranked mutual information values indicates an order of importance of each corresponding available feature;
determining a cumulative sum of the mutual information values; and
retaining available features accounting for a threshold percentage of the cumulative sum of the mutual information values; and
selecting one or more of the retained available features based on a Random Forest selection technique comprising:
splitting the dataset into a training set and a testing set;
training a Random Forest classifier model on the training set using the retained available features;
extracting a respective feature importance from the Random Forest classifier model for each of the retained available features, the feature importance indicating a respective predictive contribution for each of the retained available features;
determining a mean importance score for the retained available features; and
selecting only features, among the retained available features, having an extracted respective feature importance exceeding the mean importance score;
generating a multilayer perceptron (MLP) model comprising:
generating an input layer comprising a number of input neurons equal to a number of the selected features from the Random Forest selection, each input neuron corresponding to a respective one of the selected features from the Random Forest selection;
generating a hidden layer comprising one or more hidden neurons, a number of hidden neurons being between one and twice the number of input neurons; and
generating an output layer comprising one or more output neurons, a number of output neurons matching a number of unique classes in the target variable;
dynamically selecting a model architecture of a plurality of versions of the MLP model by:
iteratively operating each of the plurality of versions of the MLP model, the iteratively operating comprising:
starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs;
performing multiple-fold cross-validation on each of the plurality of versions of the MLP model using same generated weights and biases in each fold;
recording performance metrics for each fold for each of the plurality of versions of the MLP model, the performance metrics comprising at least an accuracy and an F1 score;
averaging the performance metrics across all folds for each of plurality of versions of the MLP model; and
triggering a stopping mechanism when an F1 score of a given epoch fails to improve by at least a performance threshold percentage over a plurality of previous consecutive epochs or when the given epoch is a last among the plurality of epochs; and
identifying a number of hidden neurons in each of the plurality of versions of the MLP model after the stopping mechanism is triggered for each of the plurality of versions of the MLP model; and
automatically selecting a final MLP model from among the plurality of versions of the MLP model by implementing a scanner technique, the scanner technique comprising:
iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy comprising:
initializing a best accuracy value to be 0; and
until each of the plurality of versions of the MLP model has been compared, iteratively:
comparing a current accuracy value for a given one of the plurality of versions of the MLP model against the best accuracy value; and
responsive to the current accuracy value being greater than the best accuracy value by at least a defined margin, replacing the best accuracy value with the current accuracy value; and
after the scanner technique has iterated through the performance metrics for each of the plurality of versions of the MLP model, identifying:
a final accuracy value corresponding to the best accuracy value; and
a final number of hidden neurons in the final MLP model corresponding to a one of the plurality of versions of the MLP model that has the current accuracy value that last replaced the best accuracy value.

10. The one or more non-transitory computer-readable media of claim 9, wherein the pre-processing comprises data cleaning comprising:
correcting one or more of inconsistencies or errors; and
addressing missing information using one or more of imputation or deletion processes.

11. The one or more non-transitory computer-readable media of claim 9, wherein the Random Forest classifier model comprises at least 100 decision trees.

12. The one or more non-transitory computer-readable media of claim 9, wherein:
a number of the plurality of epochs is ≥1000 epochs; and
the training utilizes an Adam optimizer with cross-entropy loss for multi-class problems or binary cross-entropy loss for binary classifications.

13. The one or more non-transitory computer-readable media of claim 9, wherein the performance metrics further comprise precision and recall.

14. The one or more non-transitory computer-readable media of claim 9, wherein the performance threshold percentage for the stopping mechanism is at least 0.5% over five consecutive epochs.

15. The one or more non-transitory computer-readable media of claim 9, wherein the defined margin is 2%.

16. The one or more non-transitory computer-readable media of claim 9, wherein each MLP model comprises one of:
for multi-class classification, a categorical model comprising a hidden layer comprising Rectified Linear Unit (ReLU) activation and an output layer with softmax activation, in which the number of output neurons matches a unique class count; or
for binary classification, a binary model comprising a hidden layer with ReLU activation and an output layer with a single neuron using sigmoid activation.

17. A system, comprising:
one or more processors; and
at least one memory comprising at least one non-transitory computer-readable medium storing instructions that, when executed by at least one of the one or more processors, cause the system to perform operations, the operations comprising:
receiving a dataset;
pre-processing the dataset to prepare the dataset to be read by a machine learning system;
performing a hybrid feature selection process on the pre-processed dataset, the hybrid feature selection process comprising:
selecting one or more features based on a Mutual Information selection technique comprising:
determining mutual information values between each available feature and a target variable;
ranking the mutual information values such that an order of the ranked mutual information values indicates an order of importance of each corresponding available feature;
determining a cumulative sum of the mutual information values; and
retaining available features accounting for a threshold percentage of the cumulative sum of the mutual information values; and
selecting one or more of the retained available features based on a Random Forest selection technique comprising:
splitting the dataset into a training set and a testing set;
training a Random Forest classifier model on the training set using the retained available features;
extracting a respective feature importance from the Random Forest classifier model for each of the retained available features, the feature importance indicating a respective predictive contribution for each of the retained available features;
determining a mean importance score for the retained available features; and
selecting only features, among the retained available features, having an extracted respective feature importance exceeding the mean importance score;
generating a multilayer perceptron (MLP) model comprising:
generating an input layer comprising a number of input neurons equal to a number of the selected features from the Random Forest selection, each input neuron corresponding to a respective one of the selected features from the Random Forest selection;
generating a hidden layer comprising one or more hidden neurons, a number of hidden neurons being between one and twice the number of input neurons; and
generating an output layer comprising one or more output neurons, a number of output neurons matching a number of unique classes in the target variable;
dynamically selecting a model architecture of a plurality of versions of the MLP model by:
iteratively operating each of the plurality of versions of the MLP model, the iteratively operating comprising:
starting with one hidden neuron for a first version of the MLP model and increasing the number of hidden neurons by one for each subsequent version of the MLP model until the number of hidden neurons equals twice the number of input neurons for a last version of the MLP model among the plurality of versions of the MLP model, training each of the plurality of versions of the MLP model on the dataset for a plurality of epochs;
performing multiple-fold cross-validation on each of the plurality of versions of the MLP model using same generated weights and biases in each fold;
recording performance metrics for each fold for each of the plurality of versions of the MLP model, the performance metrics comprising at least an accuracy and an F1 score;
averaging the performance metrics across all folds for each of plurality of versions of the MLP model; and
triggering a stopping mechanism when an F1 score of a given epoch fails to improve by at least a performance threshold percentage over a plurality of previous consecutive epochs or when the given epoch is a last among the plurality of epochs; and
identifying a number of hidden neurons in each of the plurality of versions of the MLP model after the stopping mechanism is triggered for each of the plurality of versions of the MLP model; and
automatically selecting a final MLP model from among the plurality of versions of the MLP model by implementing a scanner technique, the scanner technique comprising:
iterating through the performance metrics for each of the plurality of versions of the MLP model obtained from the dynamically selecting the model architecture to compare the accuracy for each of the plurality of versions of the MLP model with an accuracy threshold, the plurality of versions of the MLP model being iterated in order according to the identified number of hidden neurons in each version of the MLP model from lowest to highest, the comparing the accuracy comprising:
initializing a best accuracy value to be 0; and
until each of the plurality of versions of the MLP model has been compared, iteratively:
comparing a current accuracy value for a given one of the plurality of versions of the MLP model against the best accuracy value; and
responsive to the current accuracy value being greater than the best accuracy value by at least a defined margin, replacing the best accuracy value with the current accuracy value; and
after the scanner technique has iterated through the performance metrics for each of the plurality of versions of the MLP model, identifying:
a final accuracy value corresponding to the best accuracy value; and
a final number of hidden neurons in the final MLP model corresponding to a one of the plurality of versions of the MLP model that has the current accuracy value that last replaced the best accuracy value.

18. The system of claim 17, wherein the pre-processing comprises data cleaning comprising:
correcting one or more of inconsistencies or errors; and
addressing missing information using one or more of imputation or deletion processes.

19. The system of claim 17, wherein the performance threshold percentage for the stopping mechanism is at least 0.5% over five consecutive epochs.

20. The system of claim 17, wherein the defined margin is 2%.

21. The system of claim 17, wherein each MLP model comprises one of:
for multi-class classification, a categorical model comprising a hidden layer comprising Rectified Linear Unit (ReLU) activation and an output layer with softmax activation, in which the number of output neurons matches a unique class count; or
for binary classification, a binary model comprising a hidden layer with ReLU activation and an output layer with a single neuron using sigmoid activation.
